(19) United States
(12) Patent Application Publication
(10) Pub. No.: US 2022/0320618 A1
(43) Pub. Date: Oct. 6, 2022

(54) LITHIUM BATTERY PROCESSING METHOD AND DEACTIVATING AGENT

(71) Applicant: Panasonic Intellectual Property Management Co., Ltd., Osaka-shi, Osaka (JP)

(72) Inventors: Hiroshi Minami, Osaka (JP); Masanobu Takeuchi, Osaka (JP)

(73) Assignee: Panasonic Intellectual Property Management Co., Ltd., Osaka-shi, Osaka (JP)

(21) Appl. No.: 17/626,991

(22) PCT Filed: Jun. 3, 2020
(86) PCT No.: PCT/JP2020/021949

§ 371 Date: Jan. 13, 2022

(30) Foreign Application Priority Data
Jul. 17, 2019 (JP) 2019-132013

(51) Int. Cl. H01M 10/54; H01M 10/052; H01M 10/0568; A62D 3/30

(52) U.S. Cl. CPC H01M 10/54; H01M 10/052; H01M 10/0568; A62D 3/30; H01M 2300/0025; A62D 2101/40

(57) ABSTRACT

Provided is a lithium battery processing method including: a step for adding a deactivating agent to the interior of a lithium battery, the deactivating agent containing at least one of iodine and an iodinated compound; or a step for adding a deactivating agent to the interior of a lithium battery having a fluorine-containing electrolyte, the deactivating agent containing a quaternary ammonium compound.

### TECHNICAL FIELD

The present disclosure relates to a method of treating a lithium battery.

### BACKGROUND ART

Lithium batteries, which are small, light, and have a high energy density and an excellent output density, are used for portable power supplies for personal computers, portable devices, and the like, power supplies for driving electric vehicles, and the like. The electric vehicles (xEV) are expected as measures for the fuel regulation and the environmental conservation, and a production is prospected to increase. As a result, disposal of a large amount of batteries for vehicles in future is forecasted.

When a lithium battery is recycled or disposed, a part of the lithium battery is reused, and then the lithium battery is subjected to a deactivating treatment before disassembled to be harmless.

Patent Literature 1, for example, proposes a technique involving adding a redox shuttle agent into a non-aqueous electrolyte secondary battery to render the non-aqueous electrolyte secondary battery harmless.

Patent Literatures 2 and 3, for example, propose a technique involving immersing a lithium battery in a solution of sodium chloride, sodium sulfate, or ammonium sulfate, followed by opening to render the lithium battery harmless.

### CITATION LIST

### Patent Literature

Patent Literature 1: JP 2018-137137 A

Patent Literature 2: JP H10-223264 A

Patent Literature 3: JP 3080606 B

### SUMMARY

An object of the present disclosure is to provide a method of treating a lithium battery to rapidly render the lithium battery harmless and a deactivating agent therefor.

A method of treating a lithium battery of an aspect of the present disclosure includes a step of adding a deactivating agent into the lithium battery, wherein the deactivating agent includes at least one of iodine and an iodine compound.

A method of treating a lithium battery of an aspect of the present disclosure includes a step of adding a deactivating agent into the lithium battery having a fluorine-containing electrolyte liquid, wherein the deactivating agent includes a quaternary ammonium compound.

A deactivating agent to be added into a lithium battery, which is an aspect of the present disclosure, includes at least one of iodine and an iodine compound.

A deactivating agent to be added into a lithium battery having a fluorine-containing electrolyte liquid, which is an aspect of the present disclosure, includes a quaternary ammonium compound.

According to an aspect of the present disclosure, a lithium battery may be rapidly rendered harmless.

### BRIEF DESCRIPTION OF DRAWING

FIG. 1 is a perspective view of an example of a lithium battery.

### DESCRIPTION OF EMBODIMENTS

A method of treating a lithium battery of an aspect of the present disclosure includes a step of adding a deactivating agent into the lithium battery.

The lithium battery, which is discharged by transfer of lithium ions from a negative electrode to a positive electrode, may be a primary battery or a secondary battery. Properties and states of the lithium battery are not particularly limited as long as, for example, the lithium battery needs to be rendered harmless for recycle, disposal, and the like. Rendering harmless is referred to lowering a voltage of the lithium battery to 1 V or lower.

The method of adding the deactivating agent into the lithium battery includes: for example, injecting the deactivating agent through a vent, a liquid injecting part for an electrolyte liquid, or the like that the lithium battery has; and mechanically providing an injecting port on the lithium battery to inject the deactivating agent through the injecting port.

The deactivating agent includes at least one of iodine, an iodine compound, and a quaternary ammonium compound.

Adding the deactivating agent including iodine or the iodine compound into the lithium battery causes a reaction between lithium in the lithium battery and iodine to form a solid electrolyte. This reaction consumes lithium, which is an energy source in the lithium battery, resulting in lowering the energy of the lithium battery to be harmless.

The iodine compound may be any of an inorganic iodine compound and an organic iodine compound. Examples thereof include aluminum iodide, potassium iodide, sodium iodide, copper iodide, manganese iodide, magnesium iodide, calcium iodide, ammonium iodide, hydrogen iodide, iodic acid, ammonium iodate, potassium iodate, sodium iodate, calcium iodate, iodomethane, ethyl iodide, isopropyl iodide, ethyl iodoacetate, iodocyclohexane, iodobenzene, and iodobenzoic acid. These compounds may be used singly, or may be used in combination of two or more.

The amount of the deactivating agent including iodine or the iodine compound added may be appropriately set depending on the amount of an iodine element in the deactivating agent, a capacity of the lithium battery, and the like, and is, for example, desirably larger than a minimum amount required to react with the total amount of lithium in the lithium battery.

When a deactivating agent including neither iodine nor the iodine compound and including the quaternary ammonium compound is used, an electrolyte liquid used in the lithium battery is needed to be a fluorine-containing electrolyte liquid. Adding the deactivating agent including the quaternary ammonium compound into the lithium battery causes a reaction with fluorine included in the electrolyte liquid to generate a precipitate. This reaction lowers ion conductivity of the electrolyte liquid, resulting in lowering a voltage of the lithium battery to be harmless. The electrolyte liquid includes a non-aqueous solvent and an electrolyte salt dissolved in the non-aqueous solvent, and in a case of the fluorine-containing electrolyte liquid, a fluorine-containing electrolyte salt such as, for example, LiPF₆ is used.

When a fluorine-containing binder (for example, PVDF) is used in an electrode (a positive electrode or a negative electrode), which is a constituent of the lithium battery, fluorine in the binder and the quaternary ammonium compound are reacted, thereby a function of the binder is deteriorated, and an active material (a positive electrode active material or a negative electrode active material) becomes easier to be removed from the electrode. Thus, for example, recovery of the active material becomes easier in recycling the lithium battery.

Examples of the quaternary ammonium compound include compounds of hydroxides or salts of, for example, tetramethylammonium, tetraethylammonium, tetrapropylammonium, tetrabutylammonium, tetrapentylammonium, tetrahexylammonium, tetraheptylammonium, capryltrimethylammonium, lauryltrimethylammonium, myristyltrimethylammonium, cetyltrimethylammonium, and stearyltrimethylammonium. Among them, the tetramethylammonium compound and the tetraethylammonium compound are preferable in terms of a reactivity with the fluorine and the like. In more particular, tetramethylammonium hydroxide, tetramethylammonium chloride, tetraethylammonium hydroxide, and tetraethylammonium chloride are preferable. These compounds may be used singly, or may be used in combination of two or more thereof.

The amount of the deactivating agent including the quaternary ammonium compound added may be appropriately set depending on the amount of a quaternary ammonium compound in the deactivating agent, a capacity of the lithium battery, and the like, and is, for example, desirably larger than a minimum amount required to react with the total amount of fluorine in the lithium battery.

To facilitate the addition into the lithium battery, the deactivating agent desirably includes a solvent for dissolving or dispersing iodine, the iodine compound, or the quaternary ammonium compound. Although examples of the solvent include an aqueous solvent and a non-aqueous solvent, the non-aqueous solvent is preferable because the aqueous solvent, for example, reacts with lithium in the lithium battery to generate a gas such as hydrogen. The non-aqueous solvent is preferably a solvent having a low reactivity with a member in the lithium battery, and is preferably a non-aqueous solvent, for example, used for an electrolyte liquid of the lithium battery. Examples of the non-aqueous solvent will be described in a description of an electrolyte liquid of the lithium battery below. In particular, a mixed solvent of a cyclic compound such as ethylene carbonate (EC) and propylene carbonate (PC), and a chain compound such as diethyl carbonate (DEC) and methyl ethyl carbonate (MEC) is preferably used for the solvent of the deactivating agent. Because of its high permittivity, the cyclic compound such as EC and PC has, for example, a high ability of dissolving the quaternary ammonium compound. On the other hand, since such a solvent has a high solvent viscosity, the deactivating agent requires a time to permeate into the lithium battery. Thus, mixing of the chain compound such as DEC and MEC, which has a low solvent viscosity, lowers a viscosity of the deactivating agent and reduces a permeation time into the lithium battery to attempt to reduce the time to be harmless.

The content of iodine, iodine compound or quaternary ammonium compound in the deactivating agent is not particularly limited, and for example, preferably 5 mass % or more and 20 mass % or less, and more preferably 10 mass % or more and 15 mass % or less.

A typical recycle of the lithium battery includes incineration (removal of organic substances), crushing, and subsequently separation with a sieve to separate to: a current collector made of aluminum, copper or the like; a positive electrode active material including Co, Ni, and the like; a battery case made of iron, aluminum or the like; and the like. The positive electrode active material including Co, Ni, and the like is recycled by, for example, hydrometallurgy and following electrodeposition to generate a metal or by feeding into a blast furnace to generate an alloy material.

When the lithium battery that has been rendered harmless by addition of the deactivating agent, as in the present embodiment, is recycled, the above incineration step is unnecessary. Thus, the positive electrode active material including Co, Ni, and the like may be recycled without the incineration step, and an incineration cost and environmental measures (such as F treatment during the incineration) may be omitted. A precipitation generated by adding the deactivating agent including the quaternary ammonium compound may be easily recovered by disassembling and washing the lithium battery.

An example of the lithium battery will be described below.

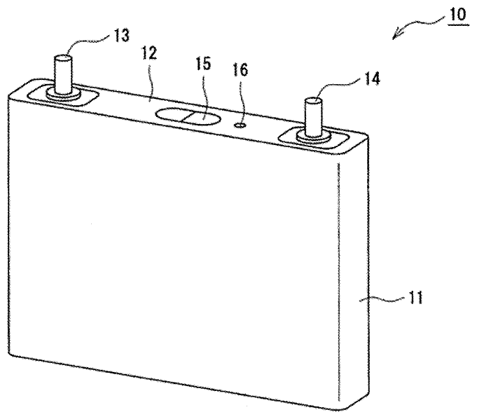

FIG. 1 is a perspective view of an example of the lithium battery. A lithium battery 10 comprises an electrode assembly, an electrolyte liquid, and a rectangular battery case housing them. The electrode assembly has a positive electrode, a negative electrode, and a separator. The electrode assembly may be a stacked electrode assembly in which a plurality of positive electrodes and a plurality of negative electrodes are alternatively stacked one by one with separators interposed therebetween, may be a wound electrode assembly in which the positive electrode and the negative electrode are spirally wound with the separator interposed therebetween, or may be another type.

The battery case comprises a substantially box-shaped case body 11 and a sealing assembly 12 sealing an opening of the case body 11. The case body 11 and the sealing assembly 12 are composed of a metal material that is mainly composed of, for example, aluminum.

On the sealing assembly 12, a positive electrode terminal 13 electrically connected to the positive electrode, a negative electrode terminal 14 electrically connected to the negative electrode, a gas discharging vent 15, and a liquid injecting part 16 are provided. The positive electrode terminal 13 and the negative electrode terminal 14 are fixed on the sealing assembly 12 with electrically insulating the sealing assembly 12 by using, for example, an insulative gasket. The liquid injecting part 16 is typically composed of a liquid injecting port to inject the electrolyte liquid and a sealing plug to seal the liquid injecting port.

The battery case is not limited to be rectangular, and may be, for example, a metal case with a shape of cylinder, coin, button, or the like, or may be a resin case (laminate) composed of resin films.

In disposal or recycle of the lithium battery 10, such as one illustrated in FIG. 1, for example, the deactivating agent is added through the liquid injecting part 16, or an opening is provided on the gas discharging vent 15 or the like and the deactivating agent is added through the opening. In a case of a cylindrical lithium battery, an opening is provided on, for example, a portion of the battery case where the electrode assembly is not in contact (for example, a central portion of the cylinder), and the deactivating agent is added through the opening.

The positive electrode, negative electrode, separator, and electrolyte liquid used in the lithium battery will be described below in detail.

[Positive Electrode]

The positive electrode comprises a positive electrode current collector and a positive electrode mixture layer formed on the current collector. For the positive electrode current collector, a foil of a metal stable within a potential range of the positive electrode, such as aluminum, a film in which such a metal is disposed on a surface layer thereof, and the like may be used. The positive electrode mixture layer includes, for example, a positive electrode active material, a conductive agent, and a binder, and is preferably formed on both surfaces of the positive electrode current collector. The positive electrode may be produced by applying a positive electrode mixture slurry including the positive electrode active material, the conductive agent, the binder, and the like on the positive electrode current collector, drying and subsequently rolling the applied film to form the positive electrode mixture layers on both the surfaces of the positive electrode current collector. From the viewpoint of increase in the battery capacity, a density of the positive electrode mixture layer is 3.6 g/cc or more, and preferably 3.6 g/cc or more and 4.0 g/cc or less.

Examples of the positive electrode active material may include a lithium metal composite oxide containing metal elements such as Co, Mn, Ni, and Al. Examples of the lithium metal composite oxide may include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (where M is at least one of the group consisting of Na, Mg, Sc, Y, Mn, Fe, Co, Ni, Cu, Zn, Al, Cr, Pb, Sb, and B, 0.95≤x≤1.2, 0.8<y≤0.95, and 2.0≤z≤2.3).

Examples of the conductive agent included in the positive electrode mixture layer may include carbon materials such as carbon black, acetylene black, Ketjenblack, graphite, carbon nanotube, carbon nanofiber, and graphene. Examples of the binder included in the positive electrode mixture layer may include fluorine-containing resins such as polytetrafluoroethylene (PTFE) and polyvinylidene fluoride (PVdF), polyacrylonitrile (PAN), a polyimide, an acrylic resin, a polyolefin, carboxymethyl cellulose (CMC) or a salt thereof, styrene-butadiene rubber (SBR), polyacrylic acid (PAA) or a salt thereof, polyvinyl alcohol (PVA), and polyethylene oxide (PEO).

[Negative Electrode]

The negative electrode comprises a negative electrode current collector and a negative electrode mixture layer formed on the negative electrode current collector. For the negative electrode current collector, a foil of a metal stable within a potential range of the negative electrode, such as copper, a film in which such a metal is disposed on a surface layer thereof, and the like may be used. The negative electrode mixture layer includes, for example, a negative electrode active material and a binder, and is preferably formed on both surfaces of the negative electrode current collector. The negative electrode may be produced by applying a negative electrode mixture slurry including the negative electrode active material, the binder, and the like on the negative electrode current collector, drying and subsequently rolling the applied film to form the negative electrode mixture layer on both the surfaces of the negative electrode current collector.

The negative electrode active material is not particularly limited as long as it may reversibly occlude and release lithium ions, and examples thereof include carbon materials such as a natural graphite and an artificial graphite, a metal to form an alloy with Li such as silicon (Si) and tin (Sn), an oxide including a metal element such as Si and Sn, and a lithium-titanium composite oxide. When the lithium-titanium composite oxide is used, the negative electrode mixture layer preferably includes a conductive agent such as carbon black. For the binder included in the negative electrode mixture layer, a material similar to that in the positive electrode is used.

[Separator]

For the separator, a porous sheet having an ion permeation property and an insulation property is used. Specific examples of the porous sheet include a fine porous thin film, a woven fabric, and a nonwoven fabric. The separator is composed of, for example, polyolefins such as polyethylene and polypropylene, cellulose, and the like. The separator may be a laminate having a cellulose fiber layer and a thermoplastic resin fiber layer such as a polyolefin. The separator may also be a multilayered separator including a polyethylene layer and a polypropylene layer, and may have a surface layer composed of an aramid resin or a surface layer containing an inorganic filler.

[Electrolyte Liquid]

The electrolyte liquid includes a non-aqueous solvent and an electrolyte salt dissolved in the non-aqueous solvent. For the non-aqueous solvent, for example, esters, ethers, nitriles such as acetonitrile, amides such as dimethylformamide, a mixed solvent of two or more thereof, and the like may be used. The non-aqueous solvent may contain a halogen-substituted solvent in which at least some hydrogens in these solvents are substituted with a halogen atom such as fluorine.

Examples of the esters include: cyclic carbonates such as ethylene carbonate (EC), propylene carbonate (PC), and butylene carbonate; chain carbonates such as dimethyl carbonate (DMC), methyl ethyl carbonate (MEC), diethyl carbonate (DEC), methyl propyl carbonate, ethyl propyl carbonate, and methyl isopropyl carbonate; cyclic carboxylates such as γ-butyrolactone (GBL) and γ-valerolactone (GVL); and chain carboxylates such as methyl acetate, ethyl acetate, propyl acetate, methyl propionate (MP), ethyl propionate, and γ-butyrolactone.

Examples of the ethers include: cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and a crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted solvent, fluorinated cyclic carbonates such as fluoroethylene carbonate (FEC), fluorinated chain carbonates, and fluorinated chain carboxylates such as methyl fluoropropionate (FMP) are preferably used.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCfF₃CO₂, Li(P(C₂O₄)F₄), LiPF₆₋ₓ(CₙF₂ₙ₊₁)ₓ (where 1<x<6 and n represents 1 or 2), LiB₁₀Cl₁₀, LiCl, LiBr, LiI, lithium chloroborane, a lithium lower aliphatic carboxylate, borate salts such as Li₂B₄O₇ and Li(B(C₂O₄)F₂), and imide salts such as LiN(SO₂CF₃)₂ and LiN(C₁F₂ₗ₊SO₂) (CₘF₂ₘ₊₁SO₂) {where 1 and m represent integers of 0 or more}. As the lithium salt, one of them may be used singly, and types of the salts may be mixed to use. Among them, LiPF₆ is preferably used from the viewpoints of ion conductivity, electrochemical stability, and the like. A concentration of the lithium salt is preferably 0.8 to 1.8 mol per 1 L of the non-aqueous solvent.

### EXAMPLES

The present disclosure will be further described below with Examples, but the present disclosure is not limited to these Examples.

[Production of Positive Electrode]

A positive electrode active material (LiCoO₂), acetylene black, and PVdF were mixed in NMP at a mass ratio of 100:1:1 to prepare a positive electrode mixture slurry. Then, the positive electrode mixture slurry was applied on both surfaces of a positive electrode current collector made of aluminum foil, the applied film was dried and then rolled with a roller, and a current collector tab made of aluminum was attached to produce a positive electrode in which a positive electrode mixture layer was formed on both the surfaces of the positive electrode current collector.

[Production of Negative Electrode]

A negative electrode active material (graphite), carboxymethyl cellulose (CMC), and a dispersion of styrene-butadiene rubber (SBR) were mixed in water at a solid content mass ratio of 98:1:1 to prepare a negative electrode mixture slurry. Then, the negative electrode mixture slurry was applied on both surfaces of a negative electrode current collector made of copper foil, the applied film was dried and then rolled with a roller, and a current collector tab made of nickel was attached to produce a negative electrode in which a negative electrode mixture layer was formed on both the surfaces of the negative electrode current collector.

[Preparation of Electrolyte Liquid]

Into a mixed solvent of ethylene carbonate (EC) and methyl ethyl carbonate (MEC) at a volume ratio of 3:7, lithium hexafluorophosphate (LiPF6) was dissolved at a concentration of 1 mol/litter to prepare an electrolyte liquid.

[Production of Lithium Battery]

The negative electrode and the positive electrode were alternatively stacked with the separator interposed therebetween to produce a stacked electrode assembly. This electrode assembly was pressed in the stacked direction, then housed in a rectangular battery case, and the electrolyte liquid was injected through a liquid injecting part to produce a rectangular test cell.

[Treatment of Rendering Lithium Battery Harmless]

### Example 1

A deactivating agent was added through the liquid injecting part in a state where the rectangular test cell had been discharged, and a voltage of the rectangular test cell was monitored. A time of reaching the voltage of 1 V or lower was measured, and the time was determined as a rendering harmless time.

As the deactivating agent, 10 mass % of tetramethylammonium hydroxide was dissolved in a mixed solvent of propylene carbonate (PC) and dimethyl carbonate (DMC) at a volume ratio of 3:7 to be used.

### Example 2

A treatment of rendering the lithium battery harmless was performed in the same manner as in Example 1 except that 10 mass % of tetramethylammonium chloride was dissolved in a mixed solvent of propylene carbonate (PC) and dimethyl carbonate (DMC) at a volume ratio of 3:7 to be used as the deactivating agent.

### Example 3

A treatment of rendering the lithium battery harmless was performed in the same manner as in Example 1 except that 10 mass % of tetraethylammonium chloride was dissolved in a mixed solvent of propylene carbonate (PC) and dimethyl carbonate (DMC) at a volume ratio of 3:7 to be used as the deactivating agent.

### Example 4

A treatment of rendering the lithium battery harmless was performed in the same manner as in Example 1 except that 10 mass % of iodine was dissolved in a dimethyl carbonate (DMC) solvent to be used as the deactivating agent.

### COMPARATIVE EXAMPLE

The liquid injecting part of the rectangular test cell was opened, filled with a NaCl solution, and immersed in a water tank to monitor a voltage of the rectangular test cell. A time of reaching the voltage of 1 V or lower (the rendering harmless time) was measured. The NaCl solution was a solution in which 5 g of NaCl was dissolved in 10 L of water.

Results of the rendering harmless times in Examples 1 to 4 and Comparative Example are summarized in Table 1.

TABLE 1

| | Deactivating | | | Rendering |
|---|---|---|---|---|
| | agent | Amount | | harmless |
| | Additive | added | Solvent | time |
| Example 1 | Tetramethyl- | 10 mass % | PC/ | 20 minute |
| | ammonium | | DMC | |
| | hydroxide | | | |
| Example 2 | Tetramethyl- | 10 mass % | PC/ | 26 minute |
| | ammonium | | DMC | |
| | chloride | | | |
| Example 3 | Tetraethyl- | 10 mass % | PC/ | 45 minute |
| | ammonium | | DMC | |
| | hydroxide | | | |
| Example 4 | Iodine | 10 mass % | DMC | 15 minute |
| Comparative | NaCl | | Water | 7 days |
| Example | | | | |

In any of Examples 1 to 4, the lithium battery was able to be rendered harmless within 45 minutes. In contrast, in Comparative Example, the lithium battery required as long as 7 days to be harmless. As can be seen, use of the deactivating agents in Examples 1 to 4 may rapidly render the lithium battery harmless.

### REFERENCE SIGNS LIST

10 Lithium battery
11 Case body
12 Sealing assembly
13 Positive electrode terminal
14 Negative electrode terminal
15 Gas discharging vent
16 Liquid injecting part

1. (canceled)

2. A method of treating a lithium battery, including:
a step of adding a deactivating agent into the lithium battery having a fluorine-containing electrolyte liquid, wherein
the deactivating agent includes a quaternary ammonium compound.

3. The method of treating a lithium battery according to claim 2, wherein the quaternary ammonium compound includes at least one of a tetramethylammonium compound and a tetraethylammonium compound.

4. (canceled)

5. A deactivating agent to be added into a lithium battery having a fluorine-containing electrolyte liquid, including:
a quaternary ammonium compound.

6. The deactivating agent according to claim 5, wherein the quaternary ammonium compound includes at least one of a tetramethylammonium compound and a tetraethylammonium compound.
